(19) United States
(12) Patent Application Publication
(10) Pub. No.: US 2017/0259610 A1
(43) Pub. Date: Sep. 14, 2017

(54) PLASMENE NANOSHEETS & METHODS OF SYNTHESIS THEREOF

(71) Applicant: MONASH UNIVERSITY, Clayton VIC (AU)

(72) Inventors: Wenlong CHENG, Wantirna South VIC (AU); Kae Jye SI, Clayton VIC (AU)

(73) Assignee: MONASH UNIVERSITY, Clayton VIC (AU)

(21) Appl. No.: 15/453,680

(22) Filed: Mar. 8, 2017

Related U.S. Application Data
(60) Provisional application No. 62/305,564, filed on Mar. 9, 2016.

(51) Int. Cl. B42D 25/378; G07D 7/12; C09D 11/03; B42D 25/29; C09D 125/06; G07D 7/00; G07D 7/20

(52) U.S. Cl. CPC B42D 25/378; G07D 7/003; G07D 7/12; G07D 7/2016; B42D 25/29; C09D 125/06; C09D 11/03; B82Y 20/00

(57) ABSTRACT

Ultrathin plasmene nanosheets are demonstrated as a new class of flexible surface enhanced Raman scattering (SERS) substrate capable of conformal attachment and sensitive and reproducible detection of chemicals on topologically complex surfaces. Engineering building block morphologies allows for fine-tuning of the SERS performance. In a preferred application the plasmene nanosheets are demonstrated as the next generation plasmonic and/or SERS coded labels, such as for example, anti-counterfeit security label for banknotes. Engineering the morphologies of plasmene-constituent nanoparticles and varying of SERS molecular labels offer virtually unlimited coding capacities.

### FIELD OF INVENTION

The present invention relates to the field of plasmonic nanoparticles, more particularly plasmonic nanoparticles based surface-enhanced Raman scattering (SERS) substrates.

In one form, the invention relates to a self-assembly strategy for synthesis of a new class of 2D plasmonic nanomaterials, known as soft plasmene nanosheets.

In another form the invention relates to plasmene nanosheets coded with plasmonic signatures or SERS fingerprints.

In one particular aspect the present invention is suitable for use in the manufacture of security, authentication or anticounterfeiting labels for valuable items such as banknotes.

It will be convenient to hereinafter describe the invention in relation to anticounterfeiting, however it should be appreciated that the present invention is not limited to that use only and that the invention can be used for labelling generally, including for inventory, classification, tracking, identification, security and authentication.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Plasmene is a term used to describe free standing, one particle thick, superlattice sheets of nanoparticles incorporating plasmonic materials. The sheets may have nanoscale thickness, but macroscopic lateral dimensions, being as thin as about 40 nm and as wide as about 3 mm, corresponding to an aspect ratio of about 75,000. Plasmonic materials, such as gold and silver, capture light and transmit it along their surfaces as waves of electrons called plasmons.

Plasmonic nanoparticles are particles having an electron density that can couple with electromagnetic radiation of wavelengths that are far larger than the particle due to the nature of the dielectric-metal interface between the medium and the particles. This differs from the behaviour in a pure metal where there is a maximum limit on the size wavelength that can be effectively coupled based on the material size. Plasmonic particles are also distinguished from normal surface plasmons by exhibiting interesting scattering, absorbance, and coupling properties.

Plasmonic nanoparticles have become a prominent research subject in the field of chemical identification due to their unprecedented ability to generate local enhanced electric fields via excitation of the localized surface plasmon resonance (LSPR) that are highly dependent on the shapes and sizes of the nanoparticles.

Exploitation of this enhanced electric field has led to development of a phenomenon known as surface-enhanced Raman scattering (SERS), in which a Raman spectrum is amplified significantly to provide a molecular fingerprint for a specific analyte via their unique vibrational signatures. As such, much research attention has been devoted to fabrication of plasmonic nanoparticles based SERS substrates, and various SERS-active substrates from metallic colloidal clusters through to lithographically patterned metal nanostructures have been demonstrated over the past two decades.

Despite this exciting progress, the current SERS substrates are predominantly associated with metal nanostructures being immobilized on rigid and/or opaque supporting substrates such as silicon, glass or quartz. This severely limits the flexibility of the substrate and prevents conformal contact with topologically complex surfaces, thus restricts SERS applications to dominantly planar surface morphologies only.

There is therefore an ongoing need to develop soft/flexible and transparent SERS substrates and expand opportunities for their application.

Just one example of a potential application of SERS substrates is in the field of labelling, particularly labelling for inventory control, classification, tracking, security for authentication and anticounterfeiting. Current anti-counterfeit technologies generally involves incorporation of nanotaggants (such as those described in patent applications US-20150185156, WO-2015133408, US-20150092811, US-20100050901 and WO-2015009239) or optically variable physical features such as security patterns or holograms which are generally made from photonic nanostructures (such as those described in patent applications US-20150183258, WO-2015066809, WO-2015034551, WO-2014187750, US-20140268332, US-20140308213, US-20060291872, RU-0002555500, CN-104369975, WO-2015018663 and EP-2816509).

The change in optical properties under external influence such as irradiation by light in the visible range of the electromagnetic spectrum allows verification of authenticity via different colour transformations. However, technological advances have made it simpler for counterfeiters to uncover and exploit these hidden security schemes. Accordingly, continuous development of new security labels with improved levels of security is important. Significant steps forward have been made with the development of nanotechnology-based security features, which exploit the unprecedented and fascinating properties of nanoparticles.

While the magnetic and fluorescence properties of nanoparticles have previously been explored, field applications utilizing optical properties based on localized surface plasmon resonance (LSPR) have been scarce. LSPR refers to the coherent collective oscillation of the conduction band electrons localized within the metal nanoparticle surface under excitation of incident light. This generates a dramatic amplification of the local electric field leading to advantageous spectroscopic applications including SERS where intrinsically inefficient Raman signals are enhanced by 4 to 10 orders in magnitude for sensitive molecular detection. SERS provides unique vibrational fingerprint (i.e. a signature) unique to a molecule and is a unique molecular identification technique. Thus, incorporation of SERS into security labels provides a new route to coding authenticity, enabling the readout of the molecule's vibrational signature which cannot be directly revealed on the basis of physical features alone.

In addition, since LSPR characteristics are intimately dependent on key parameters such as size and shape of the nanoparticles, the signature SERS responses are also dictated by these properties. Until now, substantial developments in wet chemistry synthesis has resulted in a wide range of plasmon-active nanoparticles with well-defined shapes and sizes, leading to the development of the “artificial periodic table” of plasmonic atoms. Under the guidance of plasmon hybridization theory, these artificial plasmonic atoms can be assembled into periodic nanostructure arrays with unparalleled optical signatures, opening unlimited possibilities for engineering Raman hot spots and their distribution.

Consequently, this platform of combining plasmonic nanoparticle assemblies and their tunable SERS signatures allows selective coding encryption capabilities, which hold great promise as an advanced suite of next-generation labelling, particularly for security, authentication and anti-counterfeiting strategies.

### SUMMARY OF INVENTION

An object of the present invention is to provide a new class of SERS substrates in the form of soft plasmene nanosheets.

Another object of the present invention is to provide a simple, efficient method of fabrication of soft plasmene nanosheets.

Yet another object of the present invention is to provide for attachment of soft plasmene nanosheets to topologically complex surfaces for reproducible and sensitive detection of chemicals.

Yet another object of the present invention is to provide new applications of soft plasmene nanosheets when applied to target surfaces.

Yet another object of the present invention is to provide new security labels based on plasmene nanosheets for security, anti-counterfeiting and authentication-type applications.

It is an object of the embodiments described herein to overcome or alleviate at least one of the above noted drawbacks of related art systems or to at least provide a useful alternative to related art systems.

The present invention provides a combination of polymer ligand based strategy and drying mediated air-water interfacial self assembly for fabrication of plasmene nanosheets. Thus in a first aspect of embodiments described herein there is provided a method for fabricating plasmene nanosheets the method including the steps of:
forming a film comprised of ligand functionalised nanoparticles on a liquid surface, and
allowing the film to solidify to form the plasmene nanosheet comprising the ligand functionalised nanoparticles.

The method may include the step of incorporating a Raman-active molecule to the plasmene nanosheet. This may be done by adding the Raman-active molecule to the film after it has solidified. Alternatively, the Raman-active molecule can directly incorporated onto the surface of the plasmonic nanoparticles after ligand functionalisation. The Raman molecule combined with the ligand functionalised nanoparticles is then added onto surface of the liquid for self-assembly. The Raman-active molecule may be added by any convenient means. For example, preferably the plasmene nanosheet is printable and the Raman-active molecule is included in a liquid printing or writing medium (ink).

Suitable Raman-active molecules include 4-aminothiophenol (4-ATP), malachite green, 4-mercaptobenzoic acid, 1-octadecanethiol and nile red but many other suitable molecules will be readily apparent to those skilled in the art. Biomolecules such as adenine, adenosine, adenosine 5′-triphosphate, adenosine monophosphate and adenosine diphosphate are all Raman-active and exhibit SERS.

In a second aspect of embodiments described herein there is provided a flexible plasmene nanosheet fabricated according to the method of the present invention.

For example, in a preferred method a film is formed by spreading a concentrated drop of polystyrene (PS)-capped nanoparticles on the surface of a water droplet on a production surface. The production surface is preferably a structured surface with voids (such as a metal grid, preferably a holey copper grid) or a PDMS elastomer but other suitable structured surfaces will be readily apparent to the person skilled in the art.

The water droplet is allowed to evaporate, preferably at ambient temperature. This drives the self-assembly of nanoparticles into periodic arrays due to surface tension.

The film comprising the plasmonic nanoparticle arrays can be transferred to a surface of interest by various methods, such as direct stamping using a PDMS elastomer or direct assembly on the surface. The surface of interest may be planar or a topologically complex surface.

### Nanoparticles

Without wishing to be bound by theory, the nanoparticles of the present invention are in essence building blocks for assembly into periodic arrays. Nanoparticles may be isotropic or anisotropic, with shapes including but not limited to nanospheres, nanorods, nanocubes, nanobricks, nanostars, rhombic dodecahedrons and nanobipyramids.

In a preferred embodiment solution-based gold or silver plasmonic nanoparticles are grown for use in the method and nanosheet of the present invention. Bimetallic Au@Ag nanocubes (NCs) and nanobricks (NB) are particularly preferred for use as model building blocks due to their high monodispersity, easily controlled silver coating thickness and their distinct well-pronounced plasmonic resonance bands.

The synthesis of NCs and NBs and their plasmonic modes have been reported in detail in prior art literature (Si K. J. et al ACS Nano 2014, 8, 11086; Okuno Y. et al Nanoscale 2010, 2, 1489). Briefly, CTAB (Hexadecyltrimethylammonium bromide) capped Au nanorods may be synthesized first, to act as nucleation cores for subsequent homogeneous coating of Ag shell. The presence of CTAC during the coating process is crucial for uniform coating. The silver coating thickness may be tuned by adjusting the amount of Ag+ and ascorbic acid.

Each nanoparticle is functionalized with a suitable choice of soft organic ligand, such as thiolated polystyrene. Methods for preparing of ligand-capped particles may include ligand exchange or RAFT polymerization processes. This provides the nanoparticles with stability and renders them hydrophobic, which are advantageous characteristics for air-water interfacial self-assembly process.

In a particularly preferred embodiment, the present invention includes the creation and use of complex anisotropic shapes such as nanostars which exhibit unique novel properties. In a particularly preferred embodiment the nanoparticles used in the method of the present invention are gold rhombic dodecahedrons (RD) or gold nanostars (Nstr) could self-assemble to form high-quality plasmene nanosheets. More importantly, these nanosheets could be dual-coded with plasmonic signatures and SERS fingerprints, enabling them to serve as a unique identification label.

### Identification Labels

One aspect of embodiments of the present invention provides identification labels. The term identification labels is intended to include any label that imparts information, including for coding, classification, authentication, security, anti-counterfeiting or other useful purposes. With particular reference to authentication, security and anti-counterfeiting measures the optical properties and Raman enhancing power of the periodic arrays can be utilised, preferably in conjunction with Raman-active molecules to generate a dual-coded identification security feature.

In particular, plasmene nanosheets can provide additional security levels in comparison to existing labels. For instance, the first security level can be based on simple visible coloured features because these nanosheets show different colours under transmission and reflected light due to their optical properties. Comprising a Raman molecule, this leads to a second layer of security which encrypts plasmene-specific dual plasmonic and SERS authentication codes that can only be decoded upon interrogation with advanced analytical systems.

Thus the first part of the security feature is provided by the plasmonic code which relates to the optical signatures of the periodic arrays of the plasmene nanosheet itself. This plasmonic code is sensitive to the shapes and sizes of the nanoparticles building blocks.

The second part of the security feature is provided by the SERS code which relates to the SERS spectrum of the embedded Raman active molecule, enhanced by the presence of periodic arrays. This SERS code is tunable by altering the choice of Raman-active molecule and laser excitation wavelengths. In particular, the complexity of these codes can be increased by spatially and spectroscopically engineering the geometrical parameters of plasmene building blocks and the SERS excitation laser wavelength.

The second part of the security feature may be combined with the first part of the security feature by any convenient means. For example, the Raman-active molecule may be included in a liquid used as a printing or writing medium (such as a plasmonic ink) that can be applied manually or by an automated method such as printing.

For the security code readout, a UV-visible spectrophotometer and Raman spectrometer is required. Portable handheld Raman detectors can also be used, offering greater flexibility and convenience.

While the first and second parts of the security feature can be used individually, combining the first part with second part provides a dual-coded security code that is highly advantageous. In particular, the vast coding capacity provides complexity and is difficult to decrypt.

Advantageously, a plasmene labelling platform is a simple and cost effective option which can generate unlimited possibilities, including authentication codes with multiple security levels that are secure against duplication. With particular reference to application of the plasmene nanosheet of the present invention to circulating currency such as banknotes which are subjected to wear and tear, a layer of PDMS coating provides the attached nanosheets with additional durability and stability features.

Thus, in another aspect of embodiments described herein there is provided a label suitable for use as an identification label comprising a plasmene nanosheet according to the present invention wherein the nanoparticles are chosen from nanospheres, rhombic dodecahedrons or nanostars.

In yet a further aspect of embodiments described herein there is provided a plasmene nanosheet according to the present invention coded with at least one plasmonic signature.

In yet a further aspect of embodiments described herein there is provided a plasmene nanosheet according to the present invention coded with at least one SERS fingerprint.

In yet a further aspect of embodiments described herein there is provided a plasmene nanosheet according to the present invention dual-coded with at least one plasmonic signature and at least one SERS fingerprint.

In a particularly preferred embodiment, the plasmene nanosheet is applied to a banknote.

In yet a further aspect of embodiments described herein there is provided a method of labelling comprising the step of applying to an item a plasmene nanosheet according to the present invention.

In yet a further aspect of embodiments described herein there is provided a security method comprising the steps of applying an identification label comprising a plasmonic signature to the item.

In yet a further aspect of embodiments described herein there is provided a labelling system comprising a flexible plasmene nanosheet having:
a plasmonic signature, and/or
a SERS fingerprint.

Other aspects and preferred forms are disclosed in the specification and/or defined in the appended claims, forming a part of the description of the invention.

In essence, embodiments of the present invention stem from the realisation that plasmonic nanoparticles can be utilised as building blocks for assemblies into periodic arrays. Aspects of the present invention also stems from the realisation that the optical properties and Raman enhancing power of the periodic arrays can be utilised for labelling. Furthermore, it has been realised that use of these properties of periodic arrays can be used in conjunction with Raman-active molecules to enhance the labelling, for example, by generating a dual-coded identification security feature

Advantages provided by the present invention comprise the following:
plasmene nanosheets according to the present invention are mechanically robust, soft and flexible;
plasmene nanosheets according to the invention provide excellent signal reproducibility and have long-term stability;
plasmene nanosheets according to the present invention are readily attached to any surface topology, whilst maintaining the geometry of the nanosheets without breaking;
plasmene nanosheets according to the invention are optically semi-transparent, allowing attachment on surface of interest for direct SERS acquisition;
the method of fabrication according to the present invention is simple and economical;
plasmene nanosheets according to the invention can be used for identification that could be commercially implemented for real world forensic authentications;
plasmene nanosheets according to the invention can be used to create unlimited configurable optical signatures and SERS responses by engineering the shapes and sizes of the constituent plasmene building blocks;
the present invention can provide encryption of specific molecular code readout which cannot be decoded without SERS enhancement from plasmene nanosheets with selective laser source wavelength.
plasmene nanosheets according to the invention can be used to create complex security features that are highly challenging to forge;
plasmene nanosheets according to the invention can be used in automated processes such a printing;
plasmene nanosheets according to the invention can be used to create readouts that are sensitive to laser source, permitting the use of a portable handheld Raman detectors equipped with multi-excitation laser wavelengths, thus offering great flexibility and convenience.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a scheme for fabrication process of NC-plasmene nanosheet via a polystyrene-based drying-mediated self-assembly. In this scheme can be seen a water drop (1) having a layer (5) of polystyrene-functionalized NC nanoparticles, the drop (1) being located on a copper grid (3). The first step is that of the drop drying on the copper grid (3) to form the plasmene nanosheet (4), before a second step of transfer of the nanosheet (7) onto PDMS (6) for further stamping.

FIG. 2 relates to the PDMS-mediated transfer for utilization as SERS adhesive. Specifically it illustrates 4-ATP Raman spectra of plasmene nanosheets on topologically complex surfaces; FIG. 2a—Malaysian paper banknote, FIG. 2b—Australian polymer banknote and FIG. 2c—Australian metal coin. Each spectrum includes a trace relating to ATP on the note/coin surface with sheet (10), ATP on the note/coin surface without sheet (11) and the note/coin surface (12).

FIG. 3 illustrates the engineering LSPR properties of NC- and NB-plasmene nanosheets using experimental (15) and simulated (16) extinction spectra of NC-nanosheets having NC particles of the following dimension: FIGS. 3a s-NC 21×21 nm; FIG. 3b m-NC 28×28 nm; FIG. 3c l-NC 33×33 nm; FIG. 3d s-NB 30×59 nm; FIG. 3e m-NB 62×38 nm; and FIG. 3f l-NB 45×63 nm.

FIG. 4 illustrates the influence of constituent particle sizes and shapes on SERS performance. SERS enhancement factors obtained on NC-plasmene nanosheets (FIG. 4a) and NB-plasmene nanosheets (FIG. 4b) under three excitation wavelengths of 514 nm (20), 633 nm (21), and 782 nm (22).

FIG. 5 illustrates the high uniformity of SERS signals from l-NC- and m-NB-plasmene nanosheets. The drawings comprise superimposed SERS spectra obtained from 20 different spots on l-NC-plasmene nanosheets (FIG. 5a) and m-NB-plasmene nanosheets (FIG. 5b). The laser excitation wavelengths are 514 nm and 633 nm, respectively. Histograms of SERS enhancement factors on l-NC- and m-NB-plasmene nanosheets are depicted in FIG. 5c. FIG. 5d illustrates comparisons of 4-ATP spectra obtained from m-NB nanosheets (25), l-NC nanosheets (26) and commercially obtained Klarite substrate (27).

FIG. 6 illustrates RD-based plasmene labels for dual-coding authentication. FIG. 6a is a TEM image of monolayered RD-plasmene nanosheets and FIG. 6b is a zoom view of assembled RD particles, showing a hexagonal close-packed arrangement.

FIG. 7 is a schematic representation of plasmene nanosheets as anti-counterfeit label. Specifically it depicts a bank note (30) stamped in one corner with plasmene nanosheet and PDMS coated. The graph of extinction vs wavelength represents the RD plasmene label at 601 nm (31) and the banknote surface (32). The graph of Raman intensity vs Raman shift represents the RD plasmene label (31) and the banknote surface (32). The zoom view of the dominant 1078 cm-1 peak shows uniform signal reproducibility for 15 acquisitions. Combination of the plasmonic code (34) and SERS code (35) generates a dual-coded authentication code.

FIG. 8 illustrates plasmene nanosheets according to the present invention from different building block shapes and sizes. It depicts TEM images of plasmene nanosheets with building blocks of three different sizes—small (i), medium (ii) and large (iii)—in the form of nanospheres (FIG. 8a(i), FIG. 8a(ii), and FIG. 8a(iii)), rhombic dodecahedral (FIG. 8b(i), FIG. 8b(ii) and FIG. 8b(iii)) and nanostars (FIG. 8c (i), FIG. 8c(ii), and FIG. 8c(iii)). Insets show the hexagonal closed packed lattice arrangement of the assembled nanoparticles

FIG. 9 illustrates a shape-controlled plasmonic code and SERS study. It depicts a column plot showing the EF values for NS, RD and NStr based plasmene nanosheets at multiple laser excitation wavelengths. Authentication codes here are generated by combining the individual plasmonic code and SERS barcode generated at 633 nm laser excitation.

FIG. 10 illustrates size-controlled plasmonic and SERS code for nanosphere-based plasmene. A column plot shows a comparison of the EF values for small, medium and large nanosphere based plasmene nanosheets at multiple excitation wavelengths (514, 633, 782 and 830 nm). Authentication codes generated here are based on the size-induced plasmonic codes and excitation laser specific SERS barcode.

FIG. 11 illustrates the unique advantages of plasmene anti-counterfeit labels. FIG. 11a shows how the complexity of authentication codes can be increased by adapting different Raman dyes such as 4-Aminothiophenol, malachite green, 4-mercaptobenzoic acid, 1-octadecanethiol and Nile red. Different plasmonic codes can also be generated by engineering the building block shapes and sizes. FIG. 11b shows a comparison of the 1078 cm⁻¹ peak intensity for 100 folds to show the robustness of the plasmene labels with PDMS (40) and without PDMS (41). FIG. 11c illustrates a long term stability analysis of the plasmene nanosheets with PDMS (40) and without PDMS (41) upon exposure to air for 90 days.

FIG. 12 illustrates graphs of Raman intensity vs Raman shift for three inks comprising 4-aminothiophenol a Raman-active dye and Au nanorods (NR), Au nanospheres (NS) and Au nanobricks (NB). The graphs include data for NS-NS (FIG. 12a), NR-NS (FIG. 12b), NS-NB (FIG. 12c), NR-NB (FIG. 12d), NR-NR (FIG. 12e) and NB-NB (FIG. 12f).

### DETAILED DESCRIPTION

A combination of polymer-ligand-based strategy and drying-mediated air-water interfacial self-assembly was utilized for fabrication of plasmene nanosheets with Au@Ag nanocubes (NCs) as model building blocks.

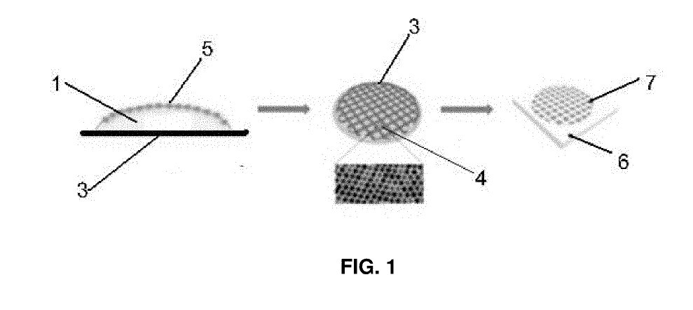

The physical steps towards obtaining a free-standing plasmene nanosheet are demonstrated in FIG. 1. In brief, a concentrated drop of polystyrene (PS)-capped NCs is spread and allowed to solidify into a monolayered film with silver-like reflection on the surface of a water droplet. Subsequent slow evaporation resulted in plasmene nanosheets which covered almost the whole grid.

One striking feature of the plasmene nanosheets is their high mechanical flexibility, which allows for a high-fidelity polydimethylsiloxane (PDMS) elastomer-mediated transfer capability, enabling them to serve as powerful “SERS adhesive” for chemical identification of trace amount of chemicals on solids of different materials with complex surface structures.

To prove this capability, 4-aminothiophenol (4-ATP) was used as a model target analyte due to its strong affinity to silver and its apparent large SERS signal. A small amount of 4-ATP was deposited and allowed to dry, before applying PDMS-mediated stamping of plasmene nanosheets onto surfaces of Malaysian banknotes (fibrous), Australian banknotes (polymer) and Australian coins (rough metal).

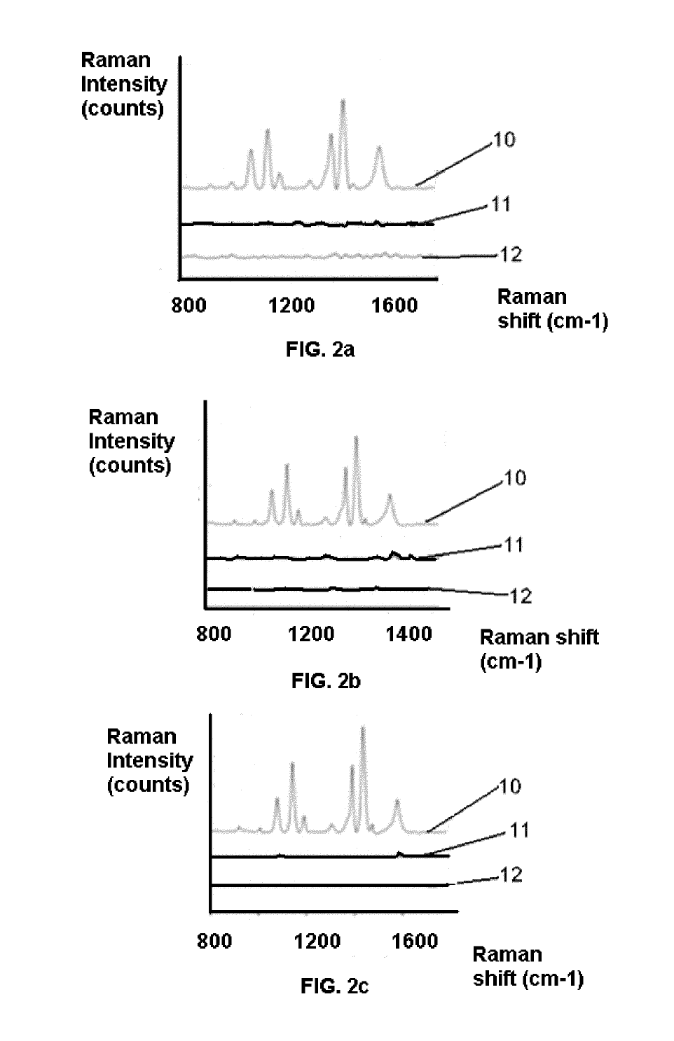

The transferred plasmene nanosheets had intimate contact with these complex surfaces due to their high flexibility and robustness, and enabled substantial signal enhancement in SERS detection of trace amount of 4-ATP molecules (FIGS. 2a, 2b & 2c). The characteristic Raman peaks for 4-ATP were not observed on the three types of solid surfaces, but became clearly evident when plasmene nanosheets were attached. This demonstrates a simple non-destructive manner for chemical identification on non-planer surfaces and the observed signal enhancing capability can potentially be extended to any other complex solid surfaces.

Further systematic investigations were carried out with respect to the influence of different sizes and shapes of constituent nanoparticle influenced the SERS enhancement. To this end, 6 plasmonic building blocks were synthesized with different geometries (small, medium, large, nanocubes (NCs) and nanobricks (NBs)) which were used to produce 6 different sheets with the same capping ligands of identical molecular lengths.

In contradistinction to NC building blocks which tend to pack side by side with regularity due to their highly ordered symmetrical nature, isotropic NBs are aligned horizontally with random packing directions to form unique monolayer NB sheets. The 2D orientational order parameter S2D was extracted by randomly selecting circular regions with various radius on the NB plasmene nanosheets. This indicated an increasing localized ordering at small region, and then decreasing after a threshold, suggesting that the packing order is close to isotropic at large dimensions.

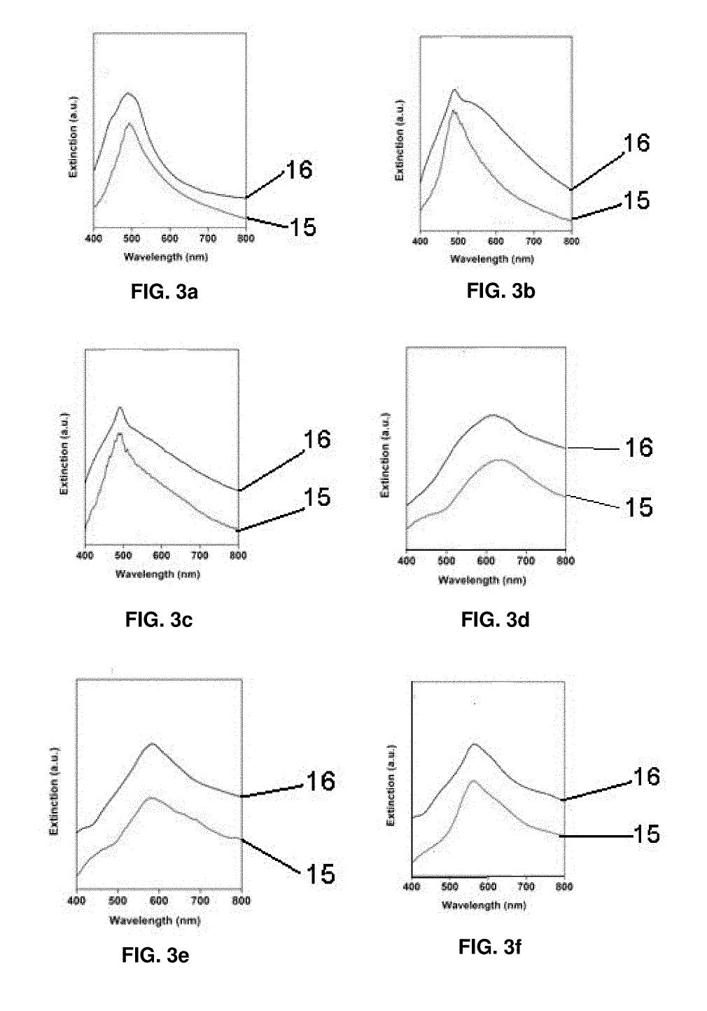

Each sheet had its own color due to the unique spectral position of the extinction resonance, which is the function of size and shape of the nanoparticles (FIG. 3). The major contribution to the extinction spectra of the sheets was found to stem from the dominant plasmonic gap modes confined to interparticle spaces in 2D planes.

The resonant peaks in the spectrum of NB sheets exhibited a significant blue shift (from 635 to 560 nm) with the thickness of silver coating (from 5 nm in s-NBs, through 9 nm in m-NBs, to 12.5 nm in l-NBs). This significant blue shift can be attributed to the sharp reduction in the aspect ratio of the NBs with increase in silver coating thickness.

In sharp contrast to this, the extinction peaks of NC sheets exhibited only a minor red shift (from 492 to 494 nm) when silver coating was increased from 5 nm in s-NCs, through 8.5 nm in m-NCs, to 11 nm in l-NCs. It is important to note that, the aspect ratio of the NCs remain unchanged, whereas the overall dimension increases as well as the edges and the corners of the NCs get sharper with increasing silver coating. Therefore, the observed minor spectral red shifts can be attributed to the modification of scattering properties of enlarged individual nanoparticles with thickening of silver coating.

The experiments with individual nanoparticles dispersed in water also revealed that the increase in silver coating had opposite effects on dipolar resonance peaks of NBs and NCs: the NBs' peak exhibited a large blue shift of ˜66 nm whereas the longitudinal dipolar peak of NCs exhibited a minor red shift of ˜24 nm.

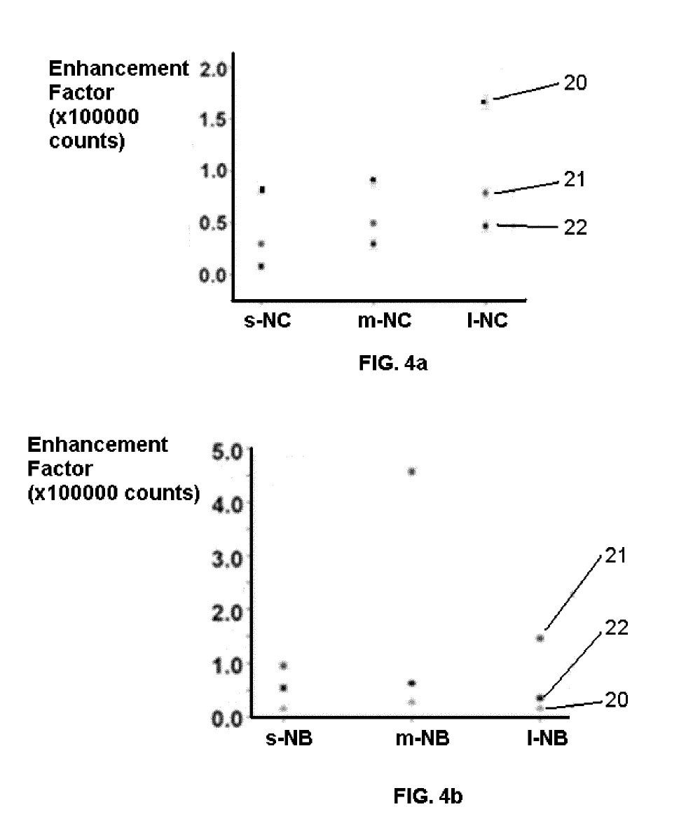

To estimate the strength of the interparticle coupling and near-field confinement, the plasmene nanosheets were patterned into square plasmene nanosheet arrays and stamped onto silicon wafers. The SERS enhancement factors (EFs) were measured at three different laser wavelengths of 514, 633, and 782 nm using 4-ATP as a Raman probe. The strongest EFs of the NC- and NB-sheets were observed at 514 nm and 633 nm wavelengths, respectively, regardless of the size of the constituent nanoparticles (FIGS. 4a & 4b). The experimentally obtained EFs matches well with theoretically predicted EF, which is proportional to the fourth power of the electric field confinement strength, EF∂(|E|/|E0|)4.

The interesting shape-discrimination phenomena could be understood from thorough DDA simulation of extinction spectra and near-field distribution. The dimensions of the nanoparticles and their spacing in a 2D array were chosen equal to the mean dimensions of NCs and NBs and the mean distances between their edges in the side-by-side (Iss) and end-to-end (Iee) orientations. Comparison of the extinction efficiencies of l-NC- and m-NB-sheets at the three laser wavelengths of 514, 633 and 782 nm showed that the strongest SERS performance corresponded to plasmene nanosheets with the highest extinction near the LSPR band. Correspondingly, the near-field intensity is strongest for NC-sheets at 514 nm; whereas the near-field intensity is strongest for NB-sheets at 633 nm.

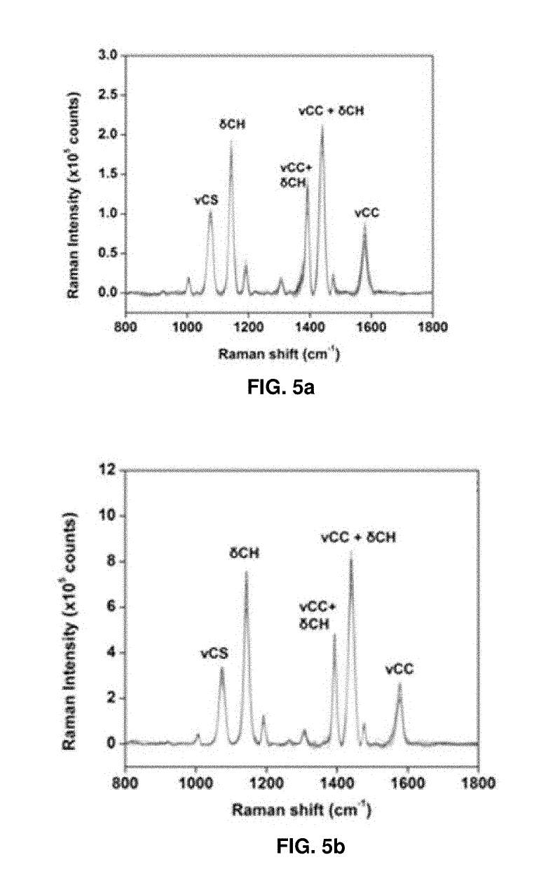

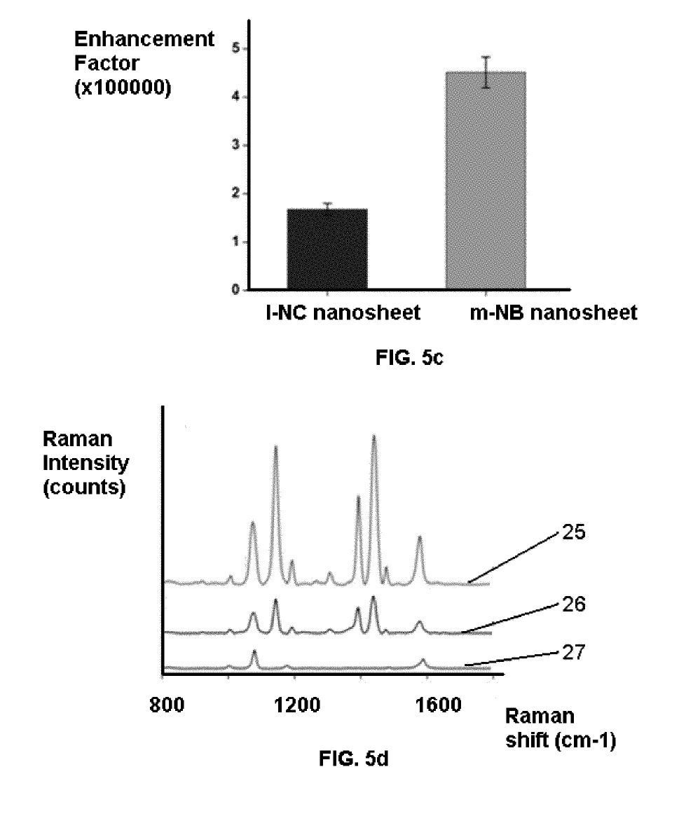

High structural homogeneity in our plasmene nanosheets led to high uniformity of SERS EFs across large area. SERS spectra of 4-ATP from 20 different spots (of about 0.8-μm2 each) on the surface of NC- and NB-sheets (FIGS. 5a & 5b) were recorded and superimposed. The almost-perfect overlap of the 20 spectra in both figures indicates an exceptional uniformity of SERS from plasmene nanosheet surface. In particular, the EFs' variances for 1078-cm-1 peak were 5.5% and 5.6% for NC- and NB-sheets, respectively (FIG. 5c). These variances are well below those reported for Klarite (10%), nanosphere arrays (10%), pyramidal arrays (9%), dry plasma-fabricated irregular particle arrays (8-9%), patterned nanoclusters (12%), and colloid-pillar arrays (5-8%).

A comparison with 4-ATP SERS spectra measured from commercially available Klarite SERS substrate proved our plasmene nanosheets demonstrated a superior SERS activity with higher sensitivity (FIG. 5d). In particular, the b2-type Raman peaks of 4-ATP (1141, 1392 and 1438 cm-1) were clearly absent from the Klarite substrate, providing crucial evidence that additional charge transfer mechanism contributes to the SERS performance of the plasmene nanosheets, rendering a great potential in application of high-performance sensor.

In addition to chemical identification of trace analytes on topologically complex surfaces, another remarkable feature demonstrated by the SERS adhesive was their ability for ultrasensitive detection of analyst in both liquid and air phase. Typically, plasmene nanosheets according to the present invention enabled detection of 4-ATP dissolved in ethanol at concentrations as low as of about 100 pM. The sheets were also vapor-permeable and could be suspended due to their mechanical robustness, which allowed for monitoring airborne analytes in real-time and in-situ. This potential application was investigated measuring the SERS spectrum of the NB-plasmene nanosheet sealed in a plastic container together with small amounts of 4-ATP powder. As the powder sublimated and the molecules of 4-ATP gradually diffused towards, and got attached to the surface, the Raman spectrum started featuring the SERS signature of 4-ATP.

Remarkably, the characteristic Raman peak at 1078 cm-1 was readily seen within the first five seconds of exposure to the 4-ATP vapor. The first 20 seconds of exposure were accompanied by a steep growth of the peak's intensity, which slowed down and got saturated in the following 40 seconds.

In summary, soft plasmene nanosheets could serve as a new class of SERS substrate which offer unique capabilities of direct surface attachability and direct SERS spectral acquisition without additional processing steps. Plasmon modes and near-field distributions in our plasmene nanosheets could be fine-tuned simply by adjusting sizes and shapes of constituent particles. Consequently, Raman hot spots could be generated at specific excitation wavelength in a highly predictable way. Beyond structural and functional programmability, plasmene nanosheets according to the present invention exhibit high structural homogeneity, enabling their uses as universal and unique SERS substrates with highly uniform Raman hotspot distributions across large area, for rapid and sensitive multi-phase detection of chemical species in air, liquid and even on topologically complex solid surfaces. The ease of self-assembly manufacturing, customizable plasmonics and superior SERS enhancements in multiphase detection make our soft plasmene nanosheet a unique sensing platform for chemical identification.

### Security Labels

The above description illustrates a robust self-assembly strategy for synthesis of 2D plasmonic nanomaterials in the form of soft plasmene nanosheets. While it will be readily apparent that successful self-assembly mechanisms work for simple nanoparticle shapes such as nanospheres, nanorods and nanocubes, it is not so apparent that complex anisotropic shapes such as nanostars may exhibit unique novel properties which can lead to unique applications.

In particular, gold nanospheres, gold rhombic dodecahedral or gold nanostars are amongst the nanoparticles that can be used to form a new security label that provides identification, such as for security, authentication and anti-counterfeit protection based on the optical characteristics of plasmonic nanoparticles.

The following description illustrates the use of two new plasmonic elements—gold rhombic dodecahedrals (RD) and gold nanostars (Nstr) which self-assemble to form high-quality plasmene nanosheets. More importantly, these nanosheets could be dual-coded with plasmonic signatures and SERS fingerprints, enabling them to be used for security applications, such as providing unique anti-counterfeit or authentication devices for banknotes.

Nine different plasmonic codes were created using gold nanospheres (NS), gold rhombic dodecahedrals (RD) and gold nanostars (Nstr) as building blocks, each with three different sizes. With the same plasmonic code, five additional SERS fingerprint barcodes were demonstrated. The facile adjustment of plasmonic codes by fine-tuning size and shapes in conjunction with choices of Raman dyes makes the system of the present invention an ideal dual-coded currency label with virtually unlimited coding capacity.

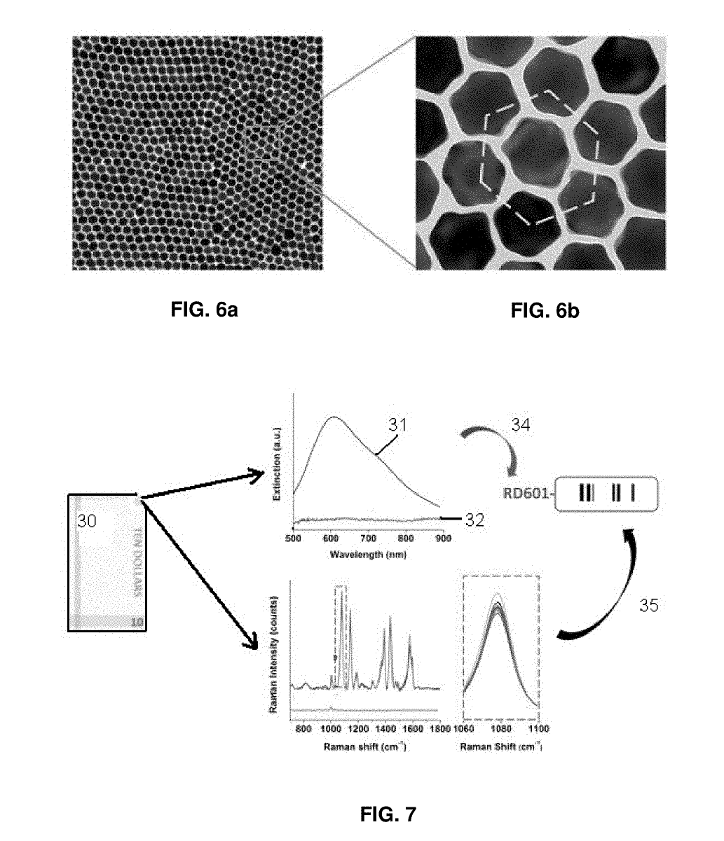

Free-standing RD-based plasmene nanosheets were fabricated using the method of the present invention. High quality and mono-dispersed RD nanoparticles were first functionalized with thiolated-polystyrene, followed by an evaporation induced self-assembly process at air-water interface into plasmene nanosheets. TEM characterization revealed the assembled nanosheet to be monolayered, with the RDs lying flat into an elongated hexagon-like shape (FIG. 6a) and exhibiting a two-dimensional hexagonally close-packed (hcp) ordering (FIG. 6b).

As a proof of the dual coding concept, a small droplet of 4-Aminothiophenol (4-ATP) solution, which is a model Raman dye with well-established characteristic vibrational fingerprints, was deposited on a banknote surface, followed by stamping of nanosheets on the deposited region and quickly spin-coated with a thin layer of PDMS (FIG. 7).

Banknote authenticity is stored in the form of a dual plasmonic and SERS coding. The plasmonic coding relates to the signature optical response of the plasmene nanosheets (FIG. 7), which was generated as RD601. SERS coding is generated by acquiring 15 SERS spectra of the deposited 4-ATP (FIG. 7). Superimposing of these spectra revealed a high degree of SERS signal uniformity (with only 3.3% variance), which can be attributed to the presence of hotspots spread homogenously throughout the plasmene nanosheets. These spectra were then averaged and each molecular vibrational fingerprint was converted into a SERS barcode.

By combining both the plasmonic code and SERS barcode together, a dual coded authentication label can be created (FIG. 7). Control spectra taken on banknote surfaces reveal no security features, implying this authentication code is specific to both the plasmene nanosheets label and the Raman dye.

To further increase the complexity of these authentication codes, we systematically adjust the shapes and sizes of the constituent nanoparticle building blocks to obtain different plasmonic codes. Mono-dispersed gold NS, gold RD and gold Nstr particles were synthesized via seeded approaches and characterized by electron microscopy and UV-vis absorption spectroscopy.

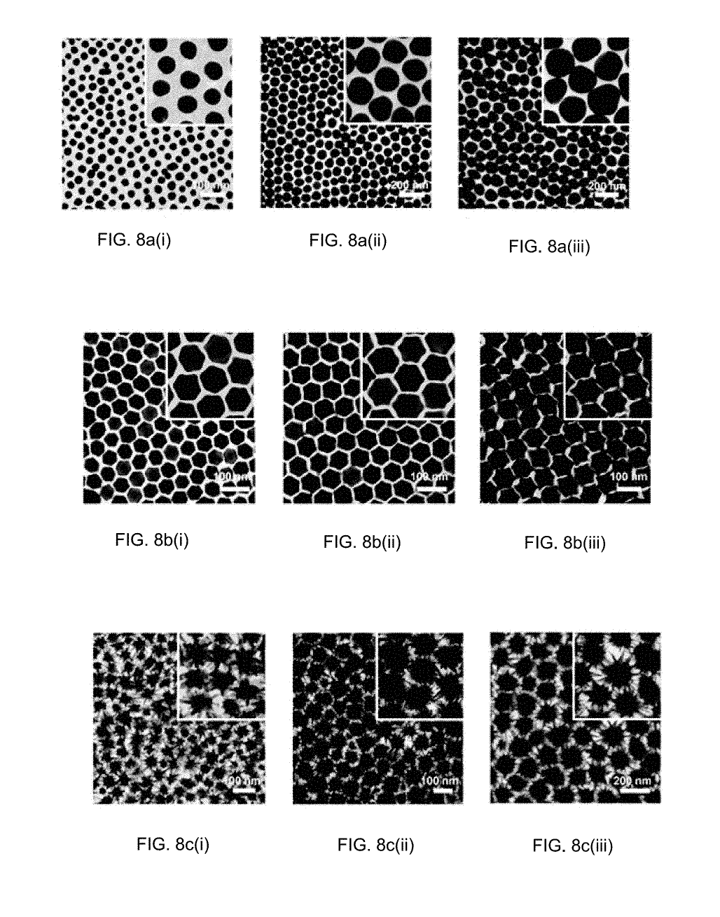

FIG. 8 shows the representative TEM images of the assembled plasmene nanosheets, each demonstrating an hcp arrangement of the gold nanoparticle arrays. Evaluation of the optical spectra of these nanosheets revealed novel resonance bands that differ from the individual nanoparticles in solution. Due to the collective coupling of the surface plasmons of nanoparticles in close proximity, extinction spectra of these nanosheets exhibited a prominent red-shift and broadening of their dominant dipolar resonance peak. In addition, the optical resonance properties are well known to be strongly influenced by the structural parameters. Hence, the geometrical sizes and shapes of the building blocks dictate the peak position of the extinction spectra and leads to generation of nine different plasmonic codes in our study (Table 1).

TABLE 1
Interparticle spacing, extinction peak and maximum enhancement
factors (EFs) for plasmene nanosheets with different building blocks

| | | | Ex- | |
|---|---|---|---|---|
| | | Interparticle | tinction | |
| Plasmene | | Spacing | peak | |
| Building Block | | (nm)^{a} | (nm)^{b} | Maximum EF |
| Nanosphere | large | 4.2 ± 1.1 | 601 | (3.20 ± 0.09) × 10⁶ |
| | medium | 7.5 ± 1.6 | 572 | (1.88 ± 0.09) × 10⁶ |
| | small | 15.2 ± 3.1 | 556 | (1.04 ± 0.06) × 10⁵ |
| Rhombic | large | 2.5 ± 0.5 | 670 | (1.51 ± 0.10) × 10⁹ |
| Dodecahedra | medium | 3.8 ± 1.0 | 635 | (5.80 ± 0.05) × 10⁸ |
| | small | 5.5 ± 1.3 | 601 | (1.70 ± 0.12) × 10⁸ |
| Nanostar | large | 119.4 ± 9.5 | NIR2 | (1.08 ± 0.11) × 10¹⁰ |
| | medium | 98.8 ± 9.3 | NIR1 | (8.42 ± 0.08) × 10⁹ |
| | small | 50.5 ± 9.2 | 603 | (0.62 ± 0.01) × 10⁹ |

^{a}For nanostar-plasmene, the interparticle spacing refers to the core-to-core distance
^{b}Due to the limitation of the UV equipment, the extinction spectra of the medium and large nanostar plasmene sheets, which were expected to be in the NIR range, were not obtained. Here, these are labelled as NIR1 and NIR2 for medium and large nanostar plasmene, respectively.

Visually, these optical responses can be evident under transmission light since different plasmene nanosheets possessed its own unique colour as a result of the spectral shifts. The maximum LSPR peaks for these nine plasmonic codes ranged from 550 nm up to the near-infrared (NIR) region.

Next, it is important to identify the minimum threshold concentrations of the SERS labels to be able to give sufficiently evident SERS signals for coding. Hence, we thoroughly investigated the relationship between the shape-controlled plasmonic codes and their SERS coding sensitivity. Using plasmene nanosheets fabricated from large-sized (L-) NS, RD and NStr particles, SERS spectra of 4-ATP at different concentrations were acquired.

ATP SERS spectra are dominated by the a1 vibrational modes, v(C-S) and v(C-C) at 1078 cm-1 and 1578 cm-1, respectively, with weaker enhancement of b2 modes at 1141 cm-1, 1180 cm-1, 1392 cm-1 and 1438 cm-1. These enhancement patterns can be explained by the two currently accepted SERS theories, with the former indicating significant contribution from electromagnetic mechanism in our system; while the latter implying the existence of weaker charge transfer mechanism due to formation of Au—S bonds. The minimal amount of ATP concentration detectable was 10-12 M, 10-18 M and 10-19 M for NS, RD and NStr plasmene, respectively, which implies the threshold concentrations of ATP molecules for these nanoparticle building blocks.

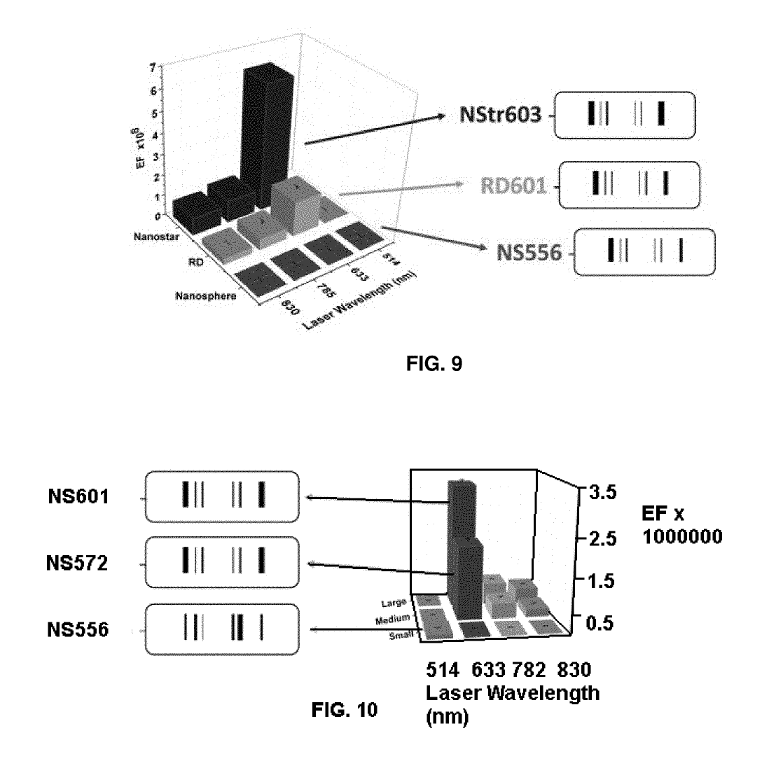

Plasmonic and SERS codes are intimately sensitive to the morphology of the plasmene constituent building blocks. FIG. 9 represents a plot of the SERS enhancement factor (EF) for three different plasmonic codes, which shows that irrespective of the laser excitation wavelength, NStr603 plasmene exhibited the strongest EF and NS556 plasmene the weakest at about 4 orders of magnitude lower. This can be explained on the basis of the electromagnetic theory and the lightning rod effect, in which the strength of localized field enhancement is intimately dependent on the presence of sharp features. Comparing the morphology of the three building blocks, it is evident that the features evolve from NS with smooth surfaces to polyhedron RDs with fourteen sharp vertices to NStr with numerous long and sharp spikes branching out from a spherical core. Hence, this explains the significant increase in the experimentally estimated EFs.

This observed trend is consistent to those demonstrated for individual nanoparticle systems. As further evidence, we performed numerical simulations to calculate the electric-field distribution of three different plasmene nanosheets made of nanoparticles of each type, where the constituent nanoparticles are arranged in an hcp lattice. Obtained near-field patterns agreed well with experimental observations, showing NS to exhibit relatively the weaker electromagnetic field intensity at surfaces in comparison to the RD vertices and NStr tips, with the strongest electric field confinement for the nanostars

Since SERS enhancement factor (EF) scales with the maximum electric field Emax (normalized to the incident electric field, E0) as power of four, the theoretical EF (EFtheoretical) can be calculated based on the following equation:

$${EF}_{theoretical} = {( \vert \frac{{E}_{max}}{{E}_{0}} \vert )}^{4} \qquad ( 1 )$$

Despite differences in the absolute values of the EFs, which can be ascribed to the limitation of simulation model in exactly replicating the actual experimental conditions, the theoretically calculated EFs follow the same sequence as obtained experimentally (EFNStr>EFRD>EFNS).

In addition to particle morphology, manipulation of the sizes of constituent building blocks and the probed laser excitation wavelengths are two other alternatives to configure the authentication coding. When building blocks increase in size, the nanoparticle core-to-core van der Waals attraction forces are expected to increase, leading to decrease in interparticle spacing (Table 1). Consequently, this resulted in localized and enhanced electric fields due to near-field coupling between neighboring particles.

As shown in FIG. 10, NS plasmene labels with different sizes give rise to different plasmonic codes and width of SERS fingerprint barcode. Comparison of the EFs shows an increasing trend with nanoparticle size as a result of the growing plasmonic coupling behaviour for larger particles. To shed light on this behaviour, simulation of the local electric-field enhancement as a function of nanoparticle size and separation was performed for NS-based plasmene nanosheets. It was observed that the maximum value of the confined electric field increases with increasing sphere diameter, where reducing interparticle spacing drastically boosts near-field coupling.

RD and NStr based-plasmene also exhibited the similar trend of EF increment with size. For RD plasmene, the sharpening of the RD vertices coupled with reduced interparticle spacing due to size increment led to increasing EF. For NStr plasmene, the increase in overall size is accompanied by the size of the star core as well as the number density, length and sharpness of the NStr branch tips. The increasing tips will significantly boost the plasmonic enhancement in comparison to the smooth core surface, resulting in increasing EF when size increases.

The maximum SERS EF can be anticipated to occur when the laser source excitation wavelength overlaps with LSPR absorption resonance. This was verified experimentally, and the maximum EF was estimated to be 3.2×106, 1.5×109 and 1.1×1010 for NS, RD and NStr plasmene at excitation wavelengths of 633 nm, 633 nm and 830 nm, respectively. As the laser excitation wavelength lies further away from the maximum peak, the SERS EF decreases (FIG. 10), which is in line with the theoretical electromagnetic mechanism prediction. These maximum EFs are relatively higher than those reported for individual particle in solution as well as self-assembled monolayer arrays, demonstrating better SERS performance for plasmene nanosheets according to the present invention.

Additionally for nanostar-based plasmene nanosheets, as the EF can hypothetically be further increased by utilizing a laser source with a wavelength closer to the near-infrared region. Interestingly, due to the broadened spectra linewidth of RD and Nstr plasmene, comparable signal amplification ability (˜1 magnitude lower) can be achieved at multiple excitation wavelengths. This opens up the potential use of one label with multiple laser wavelengths specific SERS codes, which allows specific customization and increased level of security.

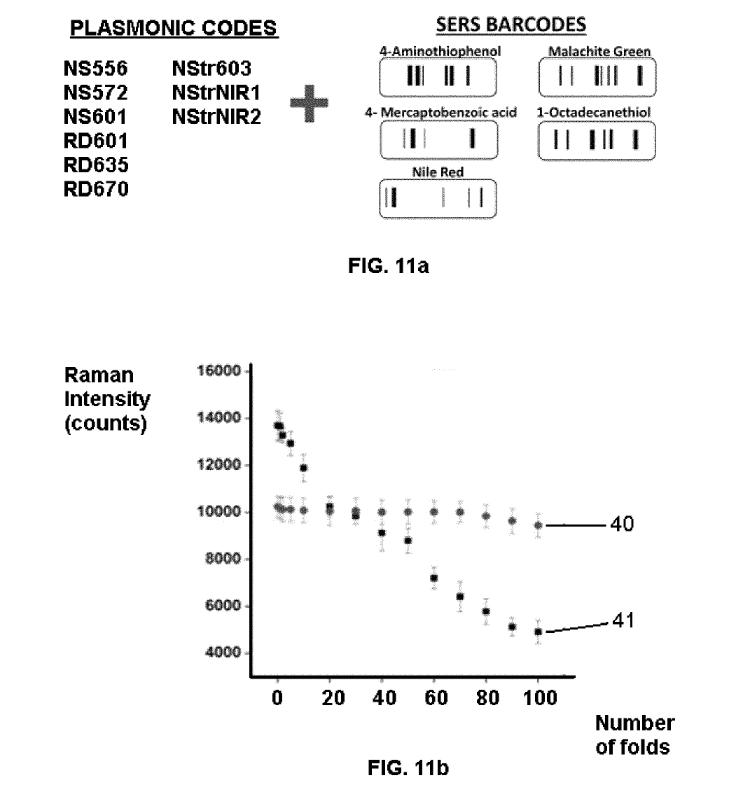

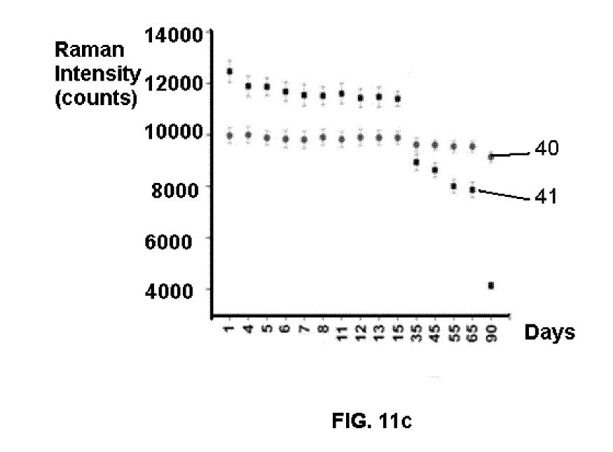

As expected, SERS barcodes could be changed arbitrarily simply by varying the choice of Raman dye that is deposited on the banknote surface. To test this, four additional SERS codes were studied. Combined with the nine different possible size and shape dependent plasmonic codes (FIG. 11a), the complexity of the authentication codes are enhanced and these are extremely challenging to decrypt or forge without sufficient prior scientific knowledge and skills.

In addition to possessing exclusive authentication characteristics, security labels should also exhibit features such as durability as well as long term stability. Here, the thin layer of PDMS coating strongly adhered plasmene nanosheets to the banknote surface and functions as a protective layer which prevents any potential surface oxidation or contamination. As a result, the plasmene nanosheets exhibited excellent durability after 100 folding cycles (FIG. 11b), and still remained a stable SERS performance after three months' time (FIG. 11c).

In summary, plasmene nanosheets which contain plasmonic signatures and SERS barcodes from molecular fingerprints can successfully be used as labels, such as security labels for items such as banknotes.

### Plasmonic Inks Including Raman-Active Molecules

Three approaches were attempted to create a liquid medium suitable for printing plasmene sheets comprising a Raman-active analyte in a plasmonic ink.

The first approach comprised the use of Au nanoparticles in a water/ligand exchange for 6 hours with a 1 mM 4-ATP-ethanol-tetrahydrofuran(THF) solution. The resulting ink exhibited very weak Raman response.

The second approach comprised adding 4 mg/ml PS-THF and 2 mg 4-ATP to a concentrated Au nanoparticle solution which was left overnight. The resulting ink initially exhibited good dispersion, but later started to aggregate, possibly due to competition between ATP and PS for surface attachment.

The third approach comprised the use of PS-THF in an overnight ligand exchange with Au nanoparticles and dispersal in 1 mg/ml 4-ATP/THF. The resultant particles were generally well dispersed. Without wishing to be bound by theory, it appears that appropriate saturation and concentration of ATP is key to ensuring that there is sufficient attachment of the Raman active molecule without unwanted displacement of ligands from the nanoparticles.

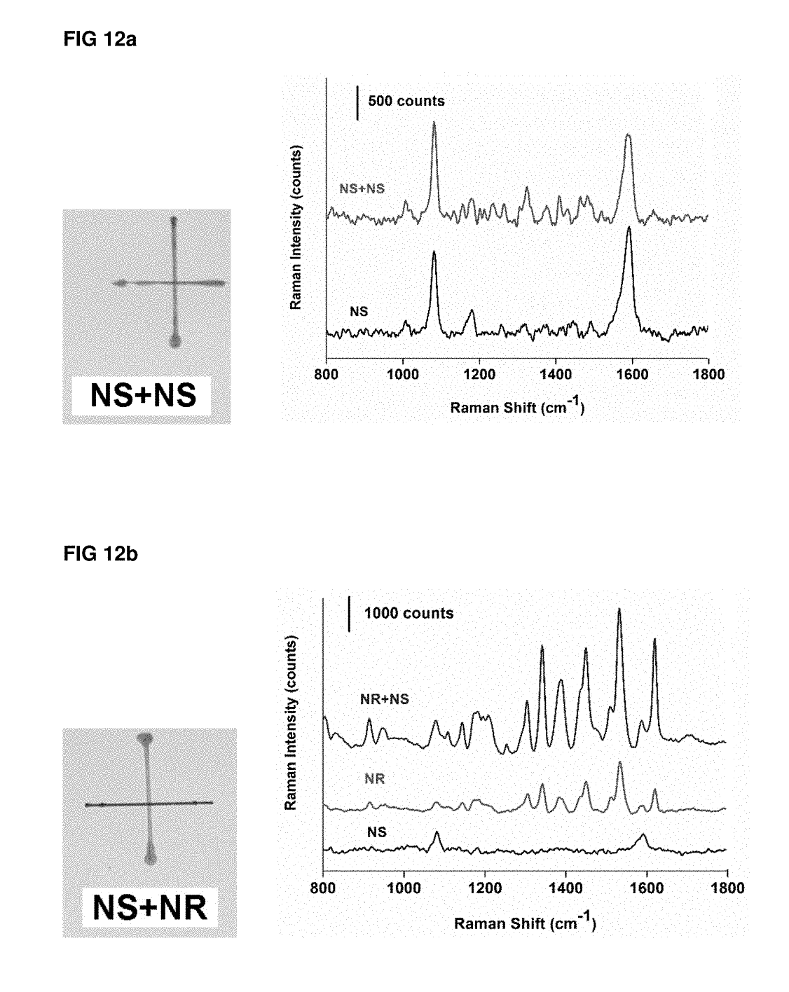

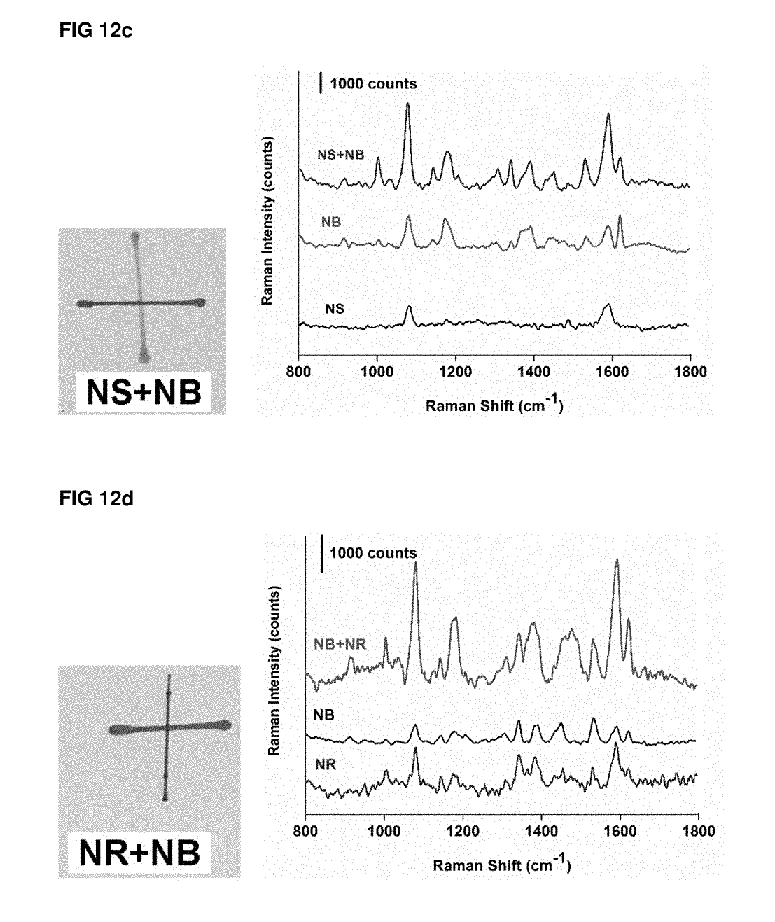

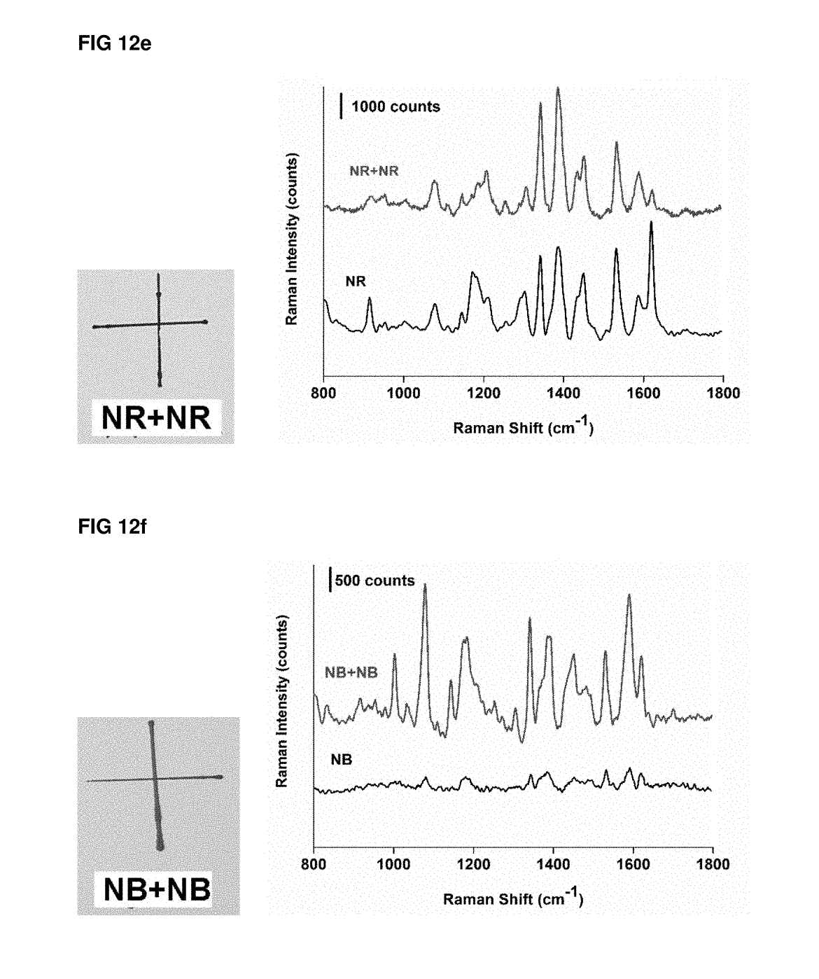

The third approach was then repeated three times using Au nanorods (NR) (2 mg Au/ml), Au nanospheres (NS) (3 mg Au/ml) and Au nanobricks (NB) (1 mg/ml) to create three printing inks. The three inks were applied to a substrate as a horizontal or vertical line (forming a cross) and their Raman spectra were recorded as shown in FIGS. 12(a) to 12(f). All the inks exhibited a clear spectrum. Raman intensity was greatest where the horizontal and vertical lines crossed, at the point of greatest particle layering and coupling.

Thus the three inks illustrate the potential for incorporating a Raman-active molecule to a plasmene nanosheet, manually, or alternatively by an automated method such as printing.

### Experimental Details

Materials: Gold (III) chloride trihydrate (HAuCl₄.3H₂O, ≧99.9%), sodium borohydride (NaBH₄), hexadecyltrimethylammonium bromide (CTAB), cetyltrimethylammonium chloride solution (CTAC, 25 wt. % in H₂O), silver nitrate (AgNO₃), L-ascorbic acid, and 4-aminothiophenol were purchased from Sigma Aldrich. Tetrahydrofuran (THF) and chloroform was obtained from Merck KGaA. Thiol-functionalized polystyrene (Mn=50,000 g/mol, Mw/Mn=1.06) was purchased from Polymer Source Inc. PDMS Sylgard (184) silicon elastomer, curing agent, and precursor were purchased from Dow Corning, USA. All chemicals were used as-received unless otherwise indicated. Deionized water was used in all aqueous solutions, which were further purified with a Milli-Q system (Millipore). All glassware used in the following procedures were cleaned in a bath of freshly prepared aqua regia and were rinsed thoroughly in H₂O prior to use. Gilder extra fine bar grids (2000 mesh with 7×7 μm2 square holes) were purchased from Ted Pella.

Nanoparticle Synthesis: Highly monodispersed CTAC-capped Au@Ag NCs and NBs were synthesized by following the recently reported approaches with slight modification. A two-step ligand exchange procedure was used to replace the weak-binding CTAC ligand with thiolated PS. Typically, as-prepared CTAC-stabilized Au@Ag NCs or NBs (5 mL) were concentrated to 0.1 mL, followed by addition of thiolated polystyrene-THF solution (2 mg mL-1) under vigorous stirring. After aging for overnight at room temperature, the supernatant was discarded and samples were purified by repeated centrifugation—precipitation cycles and re-dispersed in chloroform as a stock solution.

Mono-dispersed citrate-capped Au nanospheres were prepared according to a repeated seeded growth approach with minor modifications. A seed solution was prepared by adding sodium citrate (2 ml, 1% w/v) to a boiling HAuCl₄ solution (2.5 ml 0.2% w/v) in water (50 ml). After 10 min of vigorous stirring, the reddish seed solution was allowed to cool to room temperature. To grow nanospheres, the diluted seeds (final volume of 20 ml) was titrated slowly (45 min) with diluted HAuCl₄ solution and ascorbic acid-citrate solution (final volume of 10 ml for each solution) under vigorous stirring. After addition, the solution was heated to boiling temperature for 30-60 minutes and allowed to cool. For small sphere, 3 ml of seed, 2 ml of stock HAuCl4 (0.2% w/v), 0.5 ml of ascorbic acid (1% w/v) and 0.25 ml of sodium citrate (1% w/v) were used. The small spheres were then used as seed for a follow up growth process to obtain medium (4.5 ml seed) and large nanospheres (2 ml seed).

Rhombic Dodecahedral Synthesis: Rhombic dodecahedral (RD) nanoparticles were synthesized in a modified four-stage approach. First, nanorods were grown via a seed mediated approach. A light brown seed solution was prepared by mixing water (4.9 ml), HAuCl4 (0.1 ml, 25 mM), CTAB (5 ml, 0.2 M) and ice cold NaBH4 (0.6 ml, 10 mM) in sequence. 36 μl of this seed was then immediately added to a growth solution containing AgNO3 (0.6 ml, 4 mM), CTAB (15 ml, 0.2 M), HAuCl4 (15 ml, 1 mM) and AA (240 μl, 80 mM). The solution was then allowed to grow for 2 hours undisturbed in a 30oC bath, followed by two times centrifugation (7000 rpm, 10 min) and redispersion in 30 ml CTAB (40° C., 10 mM). For the second stage, HAuCl4 (1.5 ml, 10 mM) and AA (0.3 ml, 100 mM) were added for an hour's overgrowth process at 40° C. The overgrowth nanorods were then washed (12,000 rpm, 10 min) and redispersed in 30 ml CTAB (10 mM). Thirdly, 0.6 ml of HAuCl4 (10 mM) was added and allowed to grow in a 40oC bath for 12 hours. This resulted in transformation into a near spherical seed solution which was red in color. The seeds were washed three times (12,000 rpm, 10 min) and redispersed in 30 ml CPC solution (100 mM). For the final growth process into RD particles, the CPC seeds (varied at 0.2, 0.5 and 1 ml) were added to a growth solution containing CPC (5 ml, 10 mM), HAuCl4 (0.1 ml, 10 mM) and AA (0.2 ml, 100 mM). After 2 hours growth at 30° C., the reaction was stopped by centrifugation (12,000 rpm, 10 min)

Nanostar synthesis: Nanostars were prepared by following a modified surfactant free approach.[20] Around 12 and 35 nm cores were first prepared by adding 1.2 and 4.5 ml of citrate (1%) to 50 ml of boiling HAuCl4 solution (0.03% w/v). After 10 mins of vigorous stirring, the cores are cooled down to room temperature. For nanostar synthesis, different volumes of the core (800 μl of 12 nm core, 600 and 100 μl of the 35 nm core) were added to a growth solution of HAuCl4 (10 ml, 0.75 mM) and HCl (30 μl, 1M). Immediately, AgNO3 (300 μl, 2 mM) and AA (150 μl, 100 mM) were added simultaneously and stirred for 30 s with a rapid color change from pale red into bluish-black. The nucleation process was stopped by centrifugation (5000 rpm, 10 min) and dispersed in water.

Plasmonic Coding: Characterization of the particle morphology and optical properties of the plasmene assemblies allow generation of the plasmonic codes. Particle morphology was confirmed via electron imaging using Philips CM20 TEM or FEI Tecnai G2 T20 TEM operating at an accelerating voltage of 200 kV, or Hitachi H-7500 field emission TEM operating at 80 kV. The absorbance and extinction spectra of the bulk nanoparticle solution and plasmene nanosheets were measured using Agilent 8453 UV-Vis spectrophotometer and J&M MSP210 microscope spectrometry system, respectively. Optical micrographs of the plasmene sheets were taken by Nikon industrial bright-field microscope (ECLIPSE LV 100D) under transmission modes. These codes can be configured based on the type and size of nanoparticle building block used in plasmene assembly.

SERS Coding: Prior to Raman studies, the plasmene nanosheets were exposed to 5 minutes plasma treatment in a UV ozone chamber operating at an oxygen flowrate of 0.5 L/min. The stamping of the treated plasmene nanosheets onto silicon wafers or banknote surfaces were done with a PDMS-mediated stamping method that has been reported previously. SERS spectra were recorded by using a Renishaw RM 2000 Confocal micro-Raman System equipped with four different excitation lasers at a laser spot size of 1 μm: 514, 633, 782 and 830 nm (laser power of 0.1, 0.1, 0.03 and 0.24 mW, respectively). All Raman spectra were recorded by fine-focusing a 50× microscope objective under data acquisition time of 10 s, and corrected by cubic spline baseline subtraction. For SERS enhancement factor (EF) calculation, the strong a1-type band at 1078 cm-1 was used.

Numerical simulations: The numerical simulations of the plasmene nanosheets (made of Au nanospheres, RDs, and nanostars arranged in hexagonal lattice) were performed using CST Microwave Studio® Suite. The frequency-domain FEM solver was used to obtain the optical response of these sheets under plane wave excitation by using periodic boundary conditions in lateral directions to model the behavior of large plasmene sheets. The model parameters used in the simulations are taken from Tablel. The permittivity of gold in the nanospheres, RDs, and nanostars cores was obtained from the literature, and the sheets were assumed to be suspended in air. Open boundaries, emulating perfectly matched layers (PML), were adopted in the transverse directions so that incident light can pass the boundaries with minimal reflection. Tetrahedral meshing with automatic mesh refinement was chosen to be fine enough for the frequency-domain simulations over the wavelength range of interest. To estimate SERS performance of each sheet, we further studied the electric field distribution patterns at specific excitation laser wavelength to compare the near-field confinement strength, which roughly approximate the order of SERS intensity of the plasmene sheets. In the numerical calculations, the electric field vectors were monitored in three-dimensional mesh points to generate the electric field distribution maps. All the electric field patterns were obtained along the plane passing through the centers of the nanoparticles arranged in hexagonal lattice.

Characterization: Electron imaging was carried out using a Philips CM20 TEM or FEI Tecnai G2 T20 TEM at an acceleration voltage of 200 kV, or Hitachi H-7500 field emission TEM operating at 80 kV.

The optical extinction spectra of bulk solution samples were acquired by an Agilent 8453 UV-Vis spectrophotometer; whereas spectra of plasmene nanosheets were obtained using a J&M MSP210 microscope spectrometry system. Optical micrographs of the sheets were taken by a Nikon industrial bright field microscope (ECLIPSE LV 100D) under transmission and reflectance modes.

Raman spectra were recorded by using a Renishaw RM 2000 Confocal micro-Raman System with three different lasers at a laser spot size of 1 μm: 514, 633, and 782 nm (laser power of 0.1 mW, 0.1 mW and 0.03 mW respectively). All Raman spectra were recorded by fine-focusing a 50× microscope objective under data acquisition time of 10 s, and corrected by cubic spline baseline subtraction to exclude the fluorescence contribution. The strong a1-type band at ˜1078 cm-1 was used to calculate SERS enhancement factor (EF).

Numerical Simulations: To compute the extinction spectra of NB- and NC-sheets and to estimate the distribution of hot-spots in these sheets, an open-source numerical simulation tool was used—DDSCAT 7.2 based on DDA method which has a faster computing efficiency as compared to other numerical tools. This method allowed us to estimate the extinction of incident light by a 2D ensemble of nanoparticles (NBs or NCs), where each nanoparticle was represented as an array of polarizable point dipoles. We modeled an NB as a silver nanocuboid with a capsule shaped gold nanorod at the center, and an NC as a silver nanocube with a gold nanosphere at the core. The corners and edges of the NBs and NCs were smoothened as required to closely resemble the shapes obtained experimentally. It was estimated that the relative permittivity of the constituent materials of the nanostructures from the bulk permittivity values of gold and silver, along with size-dependent corrections whenever the shell thickness is less than the mean free path of electron in that material. The interaction of light with so designed nanoparticle (an NB or an NC, represented as an array of N dipoles) was then modeled by estimating the electric field Eⱼ of the jth dipole (j∈[1,N) as sum of incident field (E_{inc,j}) and contributions from other dipoles (E_{other,j}—represented as AⱼₗPₗ), which can be expressed as

Eⱼ=E_{inc,j}+E_{other,j}=E_{inc,j}−Σ_{l≠j}^{N}AⱼₗPₗ (1)

In the case of a 2D periodic array of NBs (or NCs) in yz plane representing plasmene nanosheet, a set of linear coupled equations were solved in DDSCAT using periodic boundary conditions along both y and z directions, where light was assumed to propagate along x direction and a target unit cell (TUC) was defined with the structural specifications of an NB (or NC). We considered the whole target as an ensemble of identical NBs or NCs (made of N dipoles, i.e. j=1, N in a TUC) arranged periodically in a 2D array (with indices m, n specifying periodic replicas of the TUC). Then, the position of (m, n)th replica of dipole j (located at rj00) can be considered as rⱼ^{mn}=rⱼ⁰⁰+mL_{y}+nLₛ, where Ly and Lz are the lattice vectors for the 2D array along y and z directions. In this case, the electric field E(rⱼ) at dipole j can be expressed as]

E(rⱼ)=E₀ exp(ik,rⱼ)+Σₗ₌₁^{N}Σ_{m=-∞}^{∞}Σ_{n=-∞}^{∞}(1−δⱼₗδₘ₀δₙ₀)Aⱼₗ^{mn}Pₗ^{mn} Equation (2)

The first term in the above expression is the electric field with wavevector k incident on dipole j at position rj. The second term denotes the total electric field contributions arising from all other dipoles in a nanoparticle and their replicas in the periodic 2D array. This can be estimated by computing Aⱼₗ^{mn} that represents a system of 3N complex linear equations for each (m, n)th replica of TUC, where δ_{xy} is the Kronecker delta and Pₗ^{mn} is the polarization of (m,n)th replica of the Ith dipole.

The polarization vector Pₗ^{mn} in Eq. (2) can be solved using DDA. With the property of lattice periodicity i.e., Pⱼ^{mn}=Pⱼ⁰⁰ exp(ikrⱼ⁰⁰), where the field of a 2D periodic lattice may be expressed in terms of the dipoles in a TUC, infinite sums in Eq. (2) can be truncated with appropriate converging functions and, then calculations of unknown polarizations were done from the reduced set of linear algebraic equation.

The extinction cross-section of such system representing plasmene nanosheet is then expressed as

$${C}_{ext} = \frac{4 π k}{{\vert {E}_{0} \vert}^{2}} {\sum }_{j = 1}^{N} Im [ {E}^{*} ( {r}_{j} ) . {P}_{j}^{00} ] , \qquad Equation ( 3 )$$

where k=2π/λ is the wave number and E0 is the amplitude of the incident plane wave.

Based on this, the extinction efficiency (Qₑₓₜ) can be readily calculated as

Qₑₓₜ=CₑₓₜL_{y}L_{z}/(πα_{eff}²), Equation (4)

where a_{eff}=(3V/4^{π})1/3 is the radius of a sphere with volume (V) of an NB (or NC) in the target unit cell of the 2D periodic lattice.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A method for fabricating plasmene nano sheets the method including the steps of:
forming a film comprised of ligand functionalised nanoparticles on a liquid surface, and
allowing the film to solidify to form the plasmene nanosheet comprising the ligand functionalised nanoparticles.

2. A method for fabricating plasmene nanosheets according to claim 1 which further includes the step of forming the film by spreading polymer capped nanoparticles on the surface of a liquid droplet.

3. A method for fabricating plasmene nanosheets according to claim 1 which further includes the step of adding a liquid droplet to a production surface to form the liquid surface on which the film is formed.

4. A method for fabricating plasmene nanosheets according to claim 3 wherein the production surface is a metal grid.

5. A method according to claim 1 further including the step of incorporating a Raman-active molecule into the plasmene nanosheet.

6. A method according to claim 1 further including the step of applying a Raman-active molecule to the surface of the plasmene nano sheet.

7. A method according to claim 5 wherein the Raman-active molecule is chosen from the group comprising 4-aminothiophenol, malachite green, 4-mercaptobenzoic acid, 1-octadecanethiol and nile red.

8. A method according to claim 1 wherein the nanoparticles are chosen from the group comprising nanospheres, nanorods, nanocubes, nanobricks, nanostars, rhombic dodecahedrons and nanobipyramids.

9. A plasmene nanosheet fabricated according to the method of claim 1 wherein the plasmene nanosheets have one or more characteristics chosen from free-standing, softness, flexibility and optical semi-transparency.

10. A plasmene nanosheet according to claim 9 and coded with at least one plasmonic signature.

11. A plasmene nanosheet according to claim 9 and coded with at least one SERS fingerprint.

12. A plasmene nanosheet according to claim 1 printed with an ink comprising at least one Raman active molecule.

13. A banknote comprising a plasmene nanosheet according to claim 9.

14. A method of labelling an item comprising the step of applying to the item a plasmene nano sheet according to claim 9.

15. A labelling system comprising a flexible plasmene nanosheet having a plasmonic signature.

16. A labelling system comprising a flexible plasmene nanosheet having a SERS fingerprint.

17. A labelling system comprising a flexible plasmene nanosheet to which has been applied an ink comprising at least one Raman active molecule.

18. A labelling system comprising a flexible plasmene nanosheet having:
a plasmonic signature, and
a SERS fingerprint.
